(19) United States
(12) Patent Application Publication
(10) Pub. No.: US 2024/0414672 A1
(43) Pub. Date: Dec. 12, 2024

(54) CONDITIONAL LINK SYNCHRONIZATION IN NTN

(71) Applicant: Nokia Technologies Oy, Espoo (FI)

(72) Inventors: Ping YUAN, Beijing (CN); Mads LAURIDSEN, Aalborg (DK); Jingyuan SUN, Beijing (CN)

(21) Appl. No.: 18/702,177

(22) PCT Filed: Nov. 1, 2021
(86) PCT No.: PCT/CN2021/128009

§ 371 Date: Apr. 17, 2024

(51) Int. Cl. H04W 56/00; H04B 7/185

(52) U.S. Cl. CPC H04W 56/0045; H04B 7/18513; H04W 56/0015

(57) ABSTRACT

Example embodiments of the present disclosure relate to devices, methods, apparatuses and computer readable storage media for conditional link synchronization in non-terrestrial networks. In example embodiments, a first device detects system broadcasted information, if there is data to be transmitted from the first device to the second device. Alternatively, the first device detects system broadcasted information if the first device receives a request for synchronization information from the second device. If the first device receives the system broadcasted information, it generates the synchronization information based on the system broadcasted information. Further, the first device transmits the synchronization information to the second device.

### FIELD

Example embodiments of the present disclosure generally relate to the field of communications, and in particular, to devices, methods, apparatuses and computer readable storage media for conditional link synchronization in non-terrestrial networks (NTN).

### BACKGROUND

Synchronization is very important to enable NTN services in the fifth generation New Radio (5G NR) and Narrow Band Internet of Things (NBIoT)/Enhanced Machine-Type Communications (E-MTC). Currently, various synchronization mechanisms have been developed widely.

For example, ephemeris data related to a position and a movement of a satellite in space may be generated by a NTN Control Center (NCC), and then signaled to a base station. Further, the base station may broadcast the ephemeris data to user equipment (UE) periodically. The UE may determine timing advance and frequency adjustment to achieve link synchronization based on the Global Navigation Satellite System (GNSS) position information and the ephemeris data signaled by the base station. Then, the report of synchronization status may be transmitted to the base station to maintain synchronization.

However, in some scenarios where synchronization status is not necessary to be maintained all the time, unnecessary signaling interaction to maintain link synchronization status will lead to large resource overhead for both the base station and the UE.

### SUMMARY

In general, example embodiments of the present disclosure provide devices, methods, apparatuses and computer readable storage media for conditional link synchronization in NTN.

In a first aspect, a method is provided. In the method, a first device, in response to at least one of data to be transmitted to a second device, or receiving a request for synchronization information from the second device, detects system broadcasted information. Then, the first device, in response to receiving the system broadcasted information, generates the synchronization information based on the system broadcasted information. Further, the first device transmits the synchronization information to the second device.

In a second aspect, a method is provided. In the method, a second device transmits a request for synchronization information to a first device. The synchronization information is generated by the first device based on system broadcasted information received by the first device. Then, the second device receives the synchronization information from the first device.

In a third aspect, a first device is provided which comprises at least one processor and at least one memory including computer program code. The at least one memory and the computer program code are configured to, with the at least one processor, cause the first device to, in response to at least one of data to be transmitted to a second device, or receiving a request for synchronization information from the second device, detect system broadcasted information. The first device is further caused to, in response to receiving the system broadcasted information, generate the synchronization information based on the system broadcasted information. Then, the first device is further caused to transmit the synchronization information to the second device.

In a fourth aspect, a second device is provided which comprises at least one processor and at least one memory including computer program code. The at least one memory and the computer program code are configured to, with the at least one processor, cause the second device to transmit a request for synchronization information to a first device. The synchronization information is generated by the first device based on system broadcasted information received by the first device. Then, the second device is further caused to receive the synchronization information from the first device.

In a fifth aspect, there is provided an apparatus comprising means for performing the method according to the first or second aspect.

In a sixth aspect, there is provided a computer readable storage medium comprising program instructions stored thereon. The instructions, when executed by a processor of a device, cause the device to perform the method according to the first or second aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example transmission procedure of the ephemeris data;

FIG. 1B illustrates update process of the ephemeris data;

FIG. 2 illustrates an example environment in which example embodiments of the present disclosure can be implemented;

FIG. 3 illustrates a signaling flow between the first device and the second device according to some example embodiments of the present disclosure;

FIG. 4 illustrates a flowchart of an example method according to some example embodiments of the present disclosure;

FIG. 5 illustrates a flowchart of an example process implemented by the first device according to some example embodiments of the present disclosure;

FIG. 6 illustrates a flowchart of an example method according to some other example embodiments of the present disclosure;

FIG. 7 illustrates a flowchart of an example process implemented by the first device according to some example embodiments of the present disclosure; and

FIG. 8 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device via which services can be provided to a terminal device in a communication network. As an example, the network device may comprise a base station. As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “terminal device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the UE include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

In the third generation partnership project (3GPP) Release 16 (Rel-16), there are some discussions about NTN for 5G NR. Further, in Release 17 (Rel-17), some required enhancements for NTN services are specified, and on this basis, there are some discussions about NTN for NBIoT/E-MTC.

As discussed in Rel-17, it is assumed that the UE may be equipped with GNSS. In order to perform time/frequency pre-compensation, the UE may obtain GNSS information and the ephemeris data, and then determine timing advance and frequency adjustment based on the GNSS information and the ephemeris data. The corresponding timing advance and frequency adjustment may be applied in Radio Resource Control (RRC)_IDLE and RRC_CONNECTED modes.

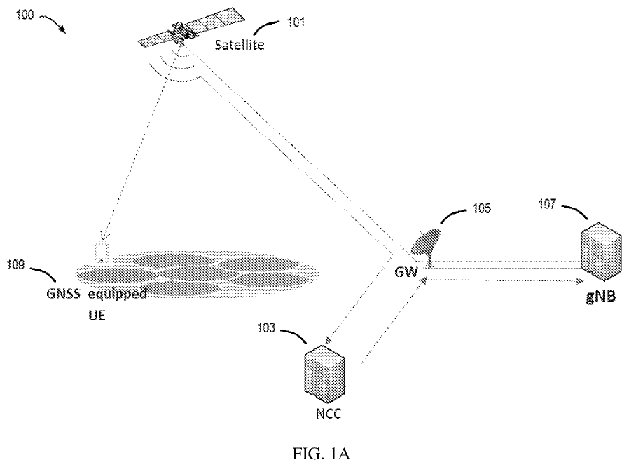

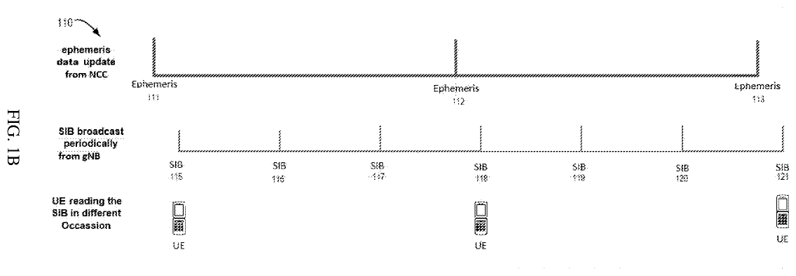

Transmission and update processes of the ephemeris data will be discussed below with reference to FIGS. 1A and 1B. Reference is first made to FIG. 1A.

As shown in FIG. 1A, measurements of the satellite position and velocity are made at the satellite 101 with on-board GNSS. The measurements are collected at the NCC 103. Further, the NCC 103 performs satellite orbit determination, which may be more or less complex depending on the models, the quantity of measurements available and the algorithms used for the satellite orbit determination. The NCC 103 generates ephemeris data and transmits the ephemeris data to the NTN gateway (GW) 105 and then signaled to the gNB 107. In another scenario, the gNB 107 may be onboard the satellite 101. Then, the gNB 107 broadcasts the ephemeris data periodically in a SIB to the GNSS equipped UE 109.

For low-earth orbit (LEO) satellites, since fast satellite movement (about 7.5 km/s relative to the earth), the satellite information (such as ephemeris data) will become outdated after a duration. It has been agreed that a validity timer should be configured by the network for the ephemeris data, to indicate the maximum time during which the UE can apply the ephemeris data for time/frequency pre-compensation without acquiring new ephemeris data. For example, epoch time may be used to determine the start time of the validity timer.

FIG. 1B illustrates update process 110 of the ephemeris data. For the purpose of discussion, the process 110 will be described with reference to FIG. 1A.

As shown in FIG. 1B, the NCC 103 generates the ephemeris data and signaled the ephemeris data towards the gNB 107 in occasions 112 and 113. The gNB 107 updates the SIB to carry the latest ephemeris data and broadcasts the latest ephemeris data in occasions 115 to 121 periodically. Accordingly, the UE 109 may receive the SIB in the different occasions, for example, in occasions 115, 118 or 121.

To keep link synchronization, the gNB and the UE may keep validity timer(s). Furthermore, it has been agreed by the 3GPP to ensure a common knowledge between the gNB and the UE about the start and value of the validity timer(s), to guarantee the gNB can only schedule a UE who may compute correct timing advance and frequency adjustment for UL transmissions based on valid ephemeris data.

In particular, the above agreement may benefit an IoT UE. The IoT UE may be half-duplex, that is, the UE may not be able to perform uplink (UL) transmission and downlink (DL) reception at the same time. The common knowledge of validity timer for ephemeris data between the gNB and the UE may ensure that the gNB may know when the UE may receive the ephemeris data and may not be able to perform UL transmission at the same time, so that the gNB will not schedule the UE to perform UL transmission in the slots when UE is receiving the ephemeris data, to avoid an unexpected scheduling from UE side.

Further it has been discussed that the validity timer for synchronization may be started/restarted at the epoch time of the assistance information (such as the ephemeris data). However, the gNB may not be able to determine which ephemeris data the UE has successfully decoded, thus gNB may not be able to know from which epoch time a validity timer should be started/restarted. Besides, by now, there is no effective way for link synchronization status between the gNB and the UE.

Example embodiments of the present disclosure provide a scheme of conditional link synchronization in NTN. With the scheme, a device (referred to as a first device), such as a UE, detects system broadcasted information, if there is data to be transmitted from the first device to another device (referred to as a second device), such as a base station. Alternatively, the first device detects system broadcasted information if the first device receives a request for synchronization information from the second device. If the first device receives the system broadcasted information, it generates the synchronization information based on the system broadcasted information. Further, the first device transmits the synchronization information to the second device. Accordingly, the second device receives the synchronization information from the first device.

This scheme reduces signaling overhead and power consumption by only achieving link synchronization if there is potential DL or UL data transmission. As such, it is allowed to achieve link synchronization between the first device and the second device flexibly and efficiently.

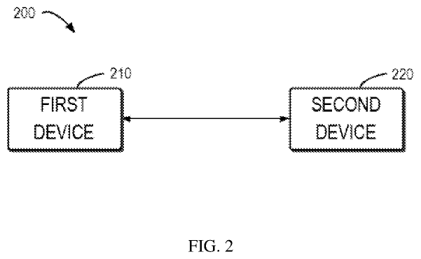

FIG. 2 shows an example environment 200 in which example embodiments of the present disclosure can be implemented.

The environment 200, which may be a part of a communication network, comprises two devices 210 and 220 communicating with each other or with other devices via each other. For the purpose of discussion, the devices 210 and 220 may be referred to as a first device 210 and a second device 220, respectively.

The first and second devices 210 and 220 may be implemented by any suitable devices in the communication network. In some example embodiments, the first device 210 may be implemented by a terminal device and the second device 220 may be implemented by a network device, or vice versa. In some other example embodiments, the first and second devices 210 and 220 may be both implemented by terminal devices or network devices. Just for the purpose of discussion, in some example embodiments, the terminal device will be taken as an example of the first device 210, and the network device will be taken as an example of the second device 220.

It is to be understood that two devices are shown in the environment 200 only for the purpose of illustration, without suggesting any limitation to the scope of the present disclosure. In some example embodiments, the environment 200 may comprise a further device to communicate synchronization assistance information with the first device 210 and the second device 220.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (cMBB), massive machine type communication (mMTC), ultra-reliable low latency communication (URLLC), Carrier Aggregation (CA), Dual Connection (DC), and New Radio Unlicensed (NR-U) technologies.

According to some example embodiments of the present disclosure, the first device 210 detects system broadcasted information, if there is data to be transmitted from the first device 210 to the second device 220. Alternatively, the first device 210 detects system broadcasted information if the first device 210 receives a request for synchronization information from the second device 220. If the first device 210 receives the system broadcasted information, it generates the synchronization information based on the system broadcasted information. Further, the first device 210 transmits the synchronization information to the second device 220. Accordingly, the second device 220 receives the synchronization information from the first device 210. Such conditional link synchronization reduces signaling overhead and power consumption.

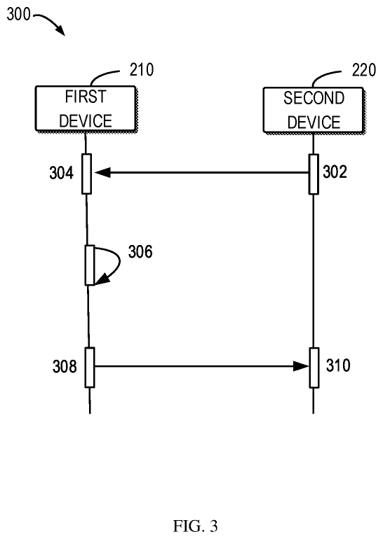

FIG. 3 shows a signaling flow 300 between the first device 210 and the second device 220 according to some example embodiments of the present disclosure. For the purpose of discussion, the signaling flow 300 will be described with reference to FIG. 2.

As shown in FIG. 3, the second device 220 transmits (302) a request for synchronization information to the first device 210. The synchronization information is generated by the first device 210 based on system broadcasted information received by the first device 210. For example, system broadcasted information may comprise ephemeris data and GNSS information. Accordingly, the first device 210 receives (304) the request for synchronization information from the second device 220. Then, the first device 210 detects system broadcasted information. Alternatively, the first device 210 may detect system broadcasted information if the first device 210 has data to be transmitted to the second device 220.

If the first device 210 receives the system broadcasted information, the first device 210 generates (306) the synchronization information based on the system broadcasted information. Then, the first device 210 transmits (308) the synchronization information to the second device 220. Accordingly, the second device 220 receives (310) the synchronization information from the first device 210.

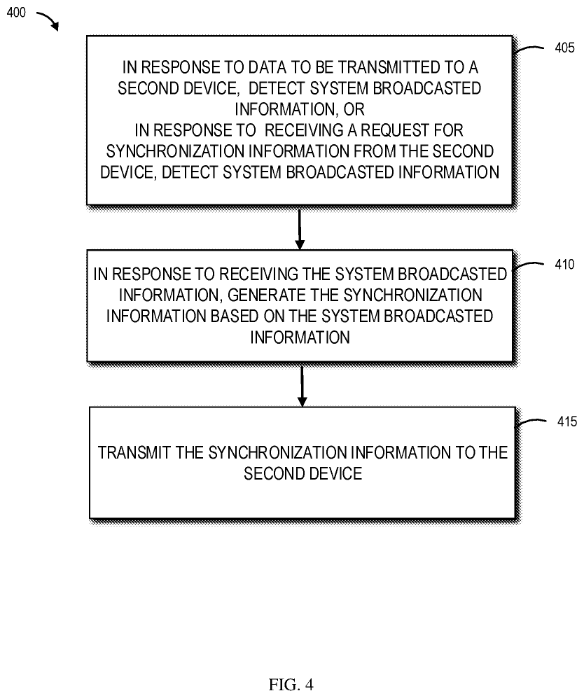

FIG. 4 shows a flowchart of an example method 400 according to some example embodiments of the present disclosure. The method 400 can be implemented by the first device 210 as shown in FIG. 2. For the purpose of discussion, the method 400 will be described with reference to FIG. 2.

As shown in FIG. 4, at block 405, the first device 210 detects system broadcasted information in response to data to be transmitted from the first device 210 to the second device 220. In some example embodiments, the first device 210 may receive an instruction from the second device 220 to cease detection of the system broadcasted information. In this case, if the first device 210 has data to be transmitted to the second device 220, it may still detect the system broadcasted information. Alternatively or in addition, if the first device 210 has no data to be transmitted, it may decide not to attempt to receive the system broadcasted information.

Alternatively, the first device 210 may detect system broadcasted information in response to receiving a request for synchronization information from the second device 220. In some example embodiments, the first device 210 may receive the request for the synchronization information on at least one of a physical downlink shared channel or a physical downlink control channel. For example, the request for the synchronization information may be received in a downlink control information (DCI) grant for scheduling or a Media Access Control (MAC) control element (CE) in a physical downlink shared channel (PDSCH), or a physical downlink control channel (PDCCH) order.

In some example embodiments, system information blocks (SIB) broadcasted by the second device 220 periodically may be used to carry the system broadcasted information. The system broadcasted information may comprise ephemeris data and GNSS information. In this case, the first device 210 may detect the system broadcasted information in the SIB.

In some example embodiments, the first device may keep a validity timer for link synchronization. The validity timer may be used to indicate the validity of the system broadcasted information. That is, if the validity timer is not expired, the first device may apply the system broadcasted information to determine the timing advance and the frequency adjustment to achieve synchronization without requiring updated system broadcasted information. Otherwise, the current system broadcasted information is invalid and cannot be used for synchronization to the second device 220.

In some example embodiments, the first device 210 may receive an indication (referred as a first indication) of a predetermined time period to maintain detection of latest system broadcasted information from the second device 220. For example, the first indication may indicate the predetermined time period by indicating a predefined number of the validity timer, or a predefined number of the SIB periodicity. Then, the first device 210 may detect the latest system broadcasted information periodically in the predetermined time period. That is, in this way, the first device 210 and the second device 220 may maintain link synchronization if the predefined number of the validity timer has not been reached, or the predefined number of the SIB periodicity has not been detected, without considering whether the first device or the second device 120 may have data to be transmitted.

In some other example embodiments, the first device 210 may receive, from the second device 220, an indication (referred as a second indication) of a predetermined number of transmissions of the synchronization information to the second device 220. In this case, the first device 210 may detect the system broadcasted information periodically and count the number of transmissions of the synchronization information. In one example, the first device 210 may only count the number of consecutive transmissions of the synchronization information when the first device 210 has no data to be transmitted. That is, the first device 210 may detect the system broadcasted information if the number of transmissions of the synchronization information is below the predetermined number of transmissions. Otherwise, if the number of transmissions of the synchronization information exceeds the predetermined number of transmissions, the first device 210 may cease to detect system broadcasted information.

As such, if there is DL or UL data arriving within the predetermined time period or when the predetermined number of transmissions of the synchronization information has not been reached, the data may be scheduled immediately since the link synchronization is maintained, that is, the system broadcasted information is valid to estimate time advance and frequency adjustment. Otherwise, if the predetermined time period has expired or the predetermined number of transmissions of the synchronization information has been reached, the link synchronization between the first device 210 and the second device 220 may be invalid. The data transmission latency may be increased since the data transmission may only be scheduled after the next link synchronization via a new synchronization trigger. With a proper configuration, the resource consumption for link synchronization and data transmission latency may be balanced.

In some example embodiments, at least one of the first indication of the predetermined time period or the second indication of the predetermined number of transmissions is contained in the request for the synchronization information. Alternatively, at least one of the above indications may be transmitted by the second device 220 in a further signalling.

As shown in FIG. 4, at block 410, the first device 210 generates the synchronization information based on the system broadcasted information in response to receiving the system broadcasted information.

In some example embodiments, the first device 210 may reset a validity timer for a validity duration of the system broadcasted information, if it receives the system broadcasted information. Alternatively, the first device 210 may reset a validity timer for a validity duration of the system broadcasted information, if it receives an acknowledge of the synchronization information from the second device 220. As such, the validity timer is available to indicate the validity of the current system broadcasted information.

For example, the validity timer may be reset based on epoch time, which is known as a reference time used for determining the start of the validity timer. For example, the epoch time may be explicitly indicated in the system broadcasted information. As an example, the epoch time may be coordinated universal time contained in the system broadcasted information. Alternatively, the epoch time may be implicitly indicated in other data, such as a system frame number and/or subframe number, an index of the system broadcasted information; or an index of a system information block for carrying the system broadcasted information.

In some example embodiments, synchronization information may indicate to the second device 220 that the system broadcasted information has been received by the first device. In some other embodiments, the synchronization information may further indicate the epoch time of the received system broadcasted information. For example, the synchronization information may comprise at least one of: timing of reception of the system broadcasted information; timing of generation of the system broadcasted information (for example, coordinated universal time contained in the system broadcasted information); time of transmission of the system broadcasted information; an index of the system broadcasted information; or an index of a system information block for carrying the system broadcasted information.

At block 415, the first device 210 transmits the synchronization information to the second device 220. For example, first device 210 may transmit the synchronization information to the second device 220 in a dedicated MAC CE or a RRC message.

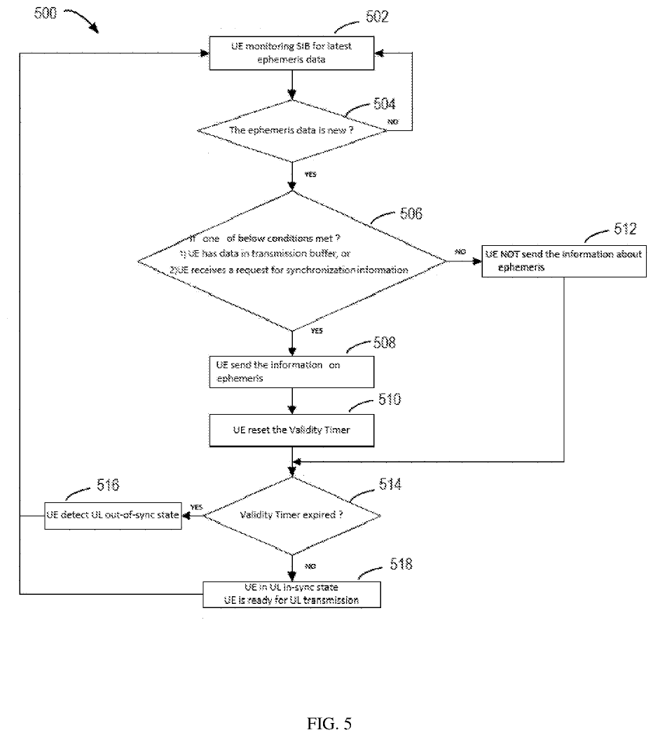

FIG. 5 illustrates a flowchart of an example process 500 implemented by the first device 210 according to some example embodiments of the present disclosure. In this example, the first device 210 is implemented by a UE and the second device 220 is implemented by a gNB. For example, the system broadcasted information refers to ephemeris data.

As shown in FIG. 5, at 502, the UE monitors latest ephemeris data. At 504, if the ephemeris data is not new, then the process 500 returns to action 502. Otherwise, if the ephemeris data is new, then the process 500 proceeds to action 506.

At 506, if the UE has data to be transmitted in transmission buffer, or if the UE receives a request for synchronization information from the gNB, the 500 proceeds to action 508. At 508, the UE sends the synchronization information comprising information on ephemeris data to the gNB for link synchronization. Then, at 510, the UE resets the validity timer. Then the process 500 proceeds to action 514.

Alternatively, at 506, if the UE has no data to be transmitted to the gNB, and the UE doesn't receive a request for synchronization information from the gNB, then at 512, the UE may not send the synchronization information about ephemeris data. Then, the process 500 proceeds to 514. At 514, if the validity timer is expired, then at 516, the UE may detect UL out-of-synchronization state, and then, the process 500 proceeds to action 502. Otherwise, at 518, the UE is in UL in-synchronization state and the UE is ready for UL transmission, and then, the process 500 proceeds to action 502.

All operations and features as described above with reference to FIGS. 2-4 are likewise applicable to the method 500 and have similar effects. For the purpose of simplification, the details will be omitted.

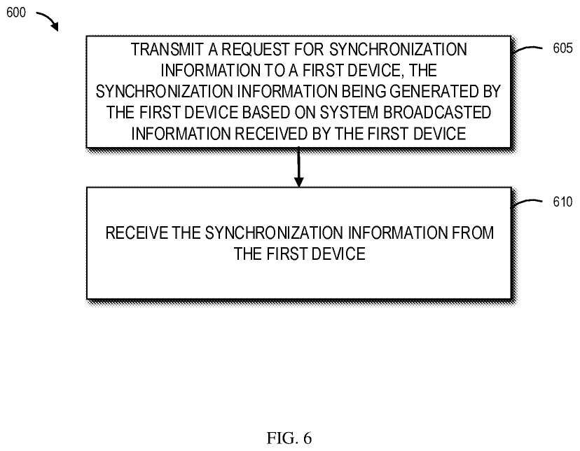

FIG. 6 shows a flowchart of an example method 600 according to some example embodiments of the present disclosure. The method 600 can be implemented by the second device 220 as shown in FIG. 2. For the purpose of discussion, the method 600 will be described with reference to FIG. 2.

As shown in FIG. 6, at block 605, the second device 220 transmits a request for synchronization information to the first device 210. As stated above, the second device 220 may transmit system broadcasted information to the first device periodically. Then, the synchronization information is generated by the first device 210 based on system broadcasted information. The synchronization information may indicate some information related to the system broadcasted information for link synchronization as discussed above. For the purpose of simplification, the details will be omitted.

In some example embodiments, the second device 220 may not keep a validity timer. In this case, the second device 220 may keep the link synchronization status for the first device 210 based on the synchronization information from the first device 210.

In some other example embodiments, the second device 220 may keep a validity timer for link synchronization. The validity timer may be set based on the synchronization information from the first device 210.

In some example embodiments, the validity duration of the system broadcasted information may be unexpired or the link synchronization status may be valid. In this case, the second device 220 may schedule the first device 210 with UL transmission, since the first device 210 may have valid system broadcasted information for link synchronization and UL transmission. The UL transmission can be either UL data transmission or UL feedback for DL data transmission, or any other UL transmission such as uplink reference signal. The second device 220 may transmit an indication to schedule the UL transmission in a DCI grant.

In this case, the second device 220 may transmit a request for synchronization information to the first device 210 if it has data to be transmitted to the first device 210. For example, the request may be transmitted in a DCI grant for the scheduling or a MAC CE in a PDSCH. Otherwise, the second device 220 may transmit an instruction to the first device 210 to cease reception of system broadcasted information, if the second device predicts that there may be no data to be transmitted to the first device 210 within the validity duration of the system broadcasted information. Accordingly, depending to the implementation at the first device 210, the link synchronization between the first device 210 and the second device 220 may be ceased to save power consumption, or the link synchronization may be maintained if the first device has data to be transmitted.

In some other example embodiments, the validity duration of the system broadcasted information may be expired or the link synchronization status may be invalid. In this case, the second device 220 may not be able to schedule the first device 210 with UL transmission, since the system broadcasted information may not be valid for link synchronization and UL transmission.

In this case, the second device 220 may transmit a further request for further synchronization information to the first device 210 if it has data to be transmitted to the first device 210. For example, the request may be transmitted in a PDCCH order. Accordingly, in response, a Hybrid Automatic Repeat Request-acknowledge (HARQ-ACK) may be received by the second device 220.

In some example embodiments, the second device 220 may transmit a first indication of a predetermined time period to maintain detection of latest system broadcasted information to the first device 210. Then, the second device 220 may receive the latest synchronization information from the first device 210 in the predetermined time period.

In some other example embodiments, the second device 220 may transmit, to the first device 210, a second indication of a predetermined number of transmissions of the synchronization information to the second device. Then, the second device 220 may receive the latest synchronization information from the first device 210 if predetermined number of transmissions of the synchronization information has not been reached.

For example, the above indications may be comprised in the request for synchronization information. Alternatively, the indication may be transmitted by the second device 220 separately. The above indications have been discussed in details with reference to FIG. 4. For the purpose of simplification, the details will be omitted.

As shown in FIG. 6, at block 610, the second device 220 receives the synchronization information from the first device 210. In some example embodiments, the second device 220 may transmit an acknowledge of the synchronization information to the first device, if it receives the synchronization information.

In some example embodiments, the second device 220 may reset the validity timer for a validity duration of the system broadcasted information, if it receives the synchronization information from the first device 210. In some other embodiments, if the second device 220 does not keep a validity timer, the second device 220 may update a link synchronization status for the first device 210, if it receives the synchronization information from the first device 210. Accordingly, if the previous link synchronization is invalid, the second device 220 may resume the scheduling for the first device 210 when the validity timer is synced-up again or when the link synchronization status is updated again.

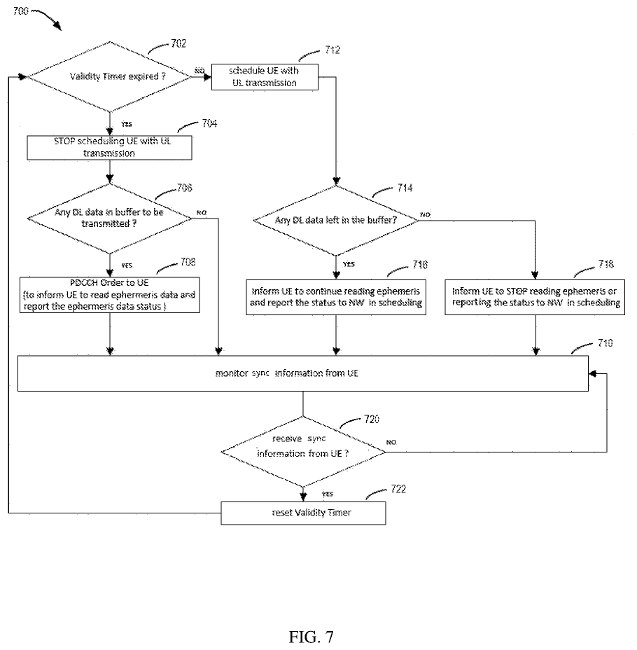

FIG. 7 illustrates a flowchart of an example process 700 implemented by the second device 220 according to some example embodiments of the present disclosure. In this example, the first device 210 is implemented by a UE and the second device 220 is implemented by a gNB. For example, the system broadcasted information refers to ephemeris data. In this example, the gNB keeps a validity timer associated with the UE.

As shown in FIG. 7, at 702, if the validity timer is expired, then at 704, the gNB stops scheduling the UE with UL transmission. At 706, if there is any DL data in the buffer to be transmitted to the UE, then at 708, the gNB transmits a further request for further synchronization information in a PDCCH order to the UE or by other means as previously mentioned, to inform the UE to read ephemeris data and report ephemeris data status to the gNB. Then, the process 700 proceeds to action 710. Otherwise, at 706, if there is no DL data in the buffer to be transmitted to the UE, then the process 700 proceeds to action 710.

Otherwise, at 702, if the validity timer is unexpired, then at 712, the gNB schedules the UE with UL transmission. At 714, if there is any DL data left in the buffer, then at 716, the gNB transmits a request for synchronization information to the UE, to inform the UE to continue reading ephemeris data and report the status to the gNB. Then, the process 700 proceeds to action 710. Otherwise, at 714, there is no DL data in the buffer to be transmitted to the UE, then at 718, the gNB transmits an instruction to the UE, to inform the UE to stop reading ephemeris data or reporting the status to the gNB. Then, the process 700 proceeds to action 710.

At 710, the gNB monitors the synchronization information from the UE. At 720, if the gNB receives the synchronization information from the UE, then at 722, the gNB reset the validity timer. Then the process 700 returns to action 702. Otherwise, at 720, if the gNB doesn't receive the synchronization information from the UE, then the process 700 returns to action 710.

All operations and features as described above with reference to FIGS. 2-6 are likewise applicable to the method 700 and have similar effects. For the purpose of simplification, the details will be omitted.

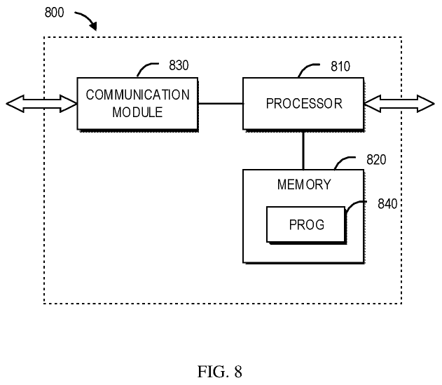

FIG. 8 is a simplified block diagram of a device 800 that is suitable for implementing example embodiments of the present disclosure. The device 800 can be implemented at or as a part of the first device 210 or the second device 220 as shown in FIG. 2.

As shown, the device 800 includes a processor 810, a memory 820 coupled to the processor 810, a communication module 830 coupled to the processor 810, and a communication interface (not shown) coupled to the communication module 830. The memory 820 stores at least a program 840. The communication module 830 is for bidirectional communications, for example, via multiple antennas. The communication interface may represent any interface that is necessary for communication.

The program 840 is assumed to include program instructions that, when executed by the associated processor 810, enable the device 800 to operate in accordance with the example embodiments of the present disclosure, as discussed herein with reference to FIGS. 2-7. The example embodiments herein may be implemented by computer software executable by the processor 810 of the device 800, or by hardware, or by a combination of software and hardware. The processor 810 may be configured to implement various example embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

When the device 800 acts as the first device 210 or a part of the first device 210, the processor 810 and the communication module 830 may cooperate to implement the method 400 as described above with reference to FIG. 2. When the device 800 acts as the second device 220 or a part of the second device 220, the processor 810 and the communication module 830 may cooperate to implement the method 600 as described above with reference to FIG. 2. All operations and features as described above with reference to FIGS. 2-7 are likewise applicable to the device 800 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 600 as described above with reference to FIG. 2. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a first device, in response to at least one of data to be transmitted to a second device, or receiving a request for synchronization information from the second device, detecting system broadcasted information; in response to receiving the system broadcasted information, generating the synchronization information based on the system broadcasted information; and transmitting the synchronization information to the second device.

In some example embodiments, the method further comprises: in response to at least one of receiving the system broadcasted information or receiving an acknowledge of the synchronization information from the second device, resetting a validity timer for a validity duration of the system broadcasted information.

In some example embodiments, the request for the synchronization information is received from the second device on at least one of a physical downlink shared channel or a physical downlink control channel.

In some example embodiments, detecting the system broadcasted information comprises: receiving, from the second device, a first indication of a predetermined time period to maintain detection of latest system broadcasted information; and detecting the latest system broadcasted information periodically in the predetermined time period.

In some example embodiments, detecting the system broadcasted information comprises: receiving, from the second device, a second indication of a predetermined number of transmissions of the synchronization information to the second device; and in accordance with a determination that the number of transmissions of the synchronization information is below the predetermined number of transmissions, detecting the system broadcasted information.

In some example embodiments, at least one of the first indication of the predetermined time period or the second indication of the predetermined number of transmissions is contained in the request for the synchronization information.

In some example embodiments, in response to the data to be transmitted to the second device, detecting the system broadcasted information comprises: receiving an instruction from the second device to cease detection of system broadcasted information; and in response to the data to be transmitted to the second device, detecting the system broadcasted information.

In some example embodiments, the synchronization information comprises at least one of: timing of reception of the system broadcasted information; timing of generation of the system broadcasted information; time of transmission of the system broadcasted information; an index of the system broadcasted information; or an index of a system information block for carrying the system broadcasted information.

In some aspects, a method comprises: at a second device, transmitting a request for synchronization information to a first device, the synchronization information being generated by the first device based on system broadcasted information received by the first device; and receiving the synchronization information from the first device.

In some example embodiments, transmitting the request for the synchronization information to the first device comprises: in response to data to be transmitted to the first device, transmitting the request for the synchronization information to the first device.

In some example embodiments, the method further comprises: in response to receiving the synchronization information from the first device: resetting a validity timer for a validity duration of the system broadcasted information, or updating a link synchronization status for the first device.

In some example embodiments, the method further comprises: in response to receiving the synchronization information from the first device, transmitting an acknowledge of the synchronization information to the first device.

In some example embodiments, the method further comprises: upon expiration of the validity timer or invalidity of the link synchronization status, transmitting a further request for further synchronization information to the first device.

In some example embodiments, the method further comprises: in response to a prediction that no data to be transmitted by the second device to the first device within the validity duration of the system broadcasted information, transmitting an instruction to the first device to cease detection of system broadcasted information.

In some example embodiments, the request for the synchronization information is transmitted to the first device on at least one of a physical downlink shared channel or a physical downlink control channel.

In some example embodiments, the method further comprises: transmitting, to the first device, a first indication of a predetermined time period to maintain detection of latest system broadcasted information.

In some example embodiments, the method further comprises: transmitting, to the first device, a second indication of a predetermined number of transmissions of the synchronization information to the second device.

In some example embodiments, at least one of the first indication of the predetermined time period or the second indication of the predetermined number of transmissions is contained in the request for the synchronization information.

In some example embodiments, the synchronization information comprises at least one of: timing of reception of the system broadcasted information; timing of generation of the system broadcasted information; time of transmission of the system broadcasted information; an index of the system broadcasted information; or an index of a system information block for carrying the system broadcasted information.

In some aspects, an apparatus implemented at a first device, comprising: at least one processor; and at least one memory including computer program code; the at least one memory and the computer program code configured to, with the at least one processor, cause the apparatus to: in response to at least one of data to be transmitted to a second device, or receiving a request for synchronization information from the second device, detect system broadcasted information; in response to receiving the system broadcasted information, generate the synchronization information based on the system broadcasted information; and transmit the synchronization information to the second device.

In some example embodiments, the apparatus is further caused to: in response to at least one of receiving the system broadcasted information or receiving an acknowledge of the synchronization information from the second device, reset a validity timer for a validity duration of the system broadcasted information.

In some example embodiments, the request for the synchronization information is received from the second device on at least one of a physical downlink shared channel or a physical downlink control channel.

In some example embodiments, the apparatus is caused to detect the system broadcasted information by: receiving, from the second device, a first indication of a predetermined time period to maintain detection of latest system broadcasted information; and detecting the latest system broadcasted information periodically in the predetermined time period.

In some example embodiments, the apparatus is caused to detect the system broadcasted information by: receiving, from the second device, a second indication of a predetermined number of transmissions of the synchronization information to the second device; and in accordance with a determination that the number of transmissions of the synchronization information is below the predetermined number of transmissions, detecting the system broadcasted information.

In some example embodiments, at least one of the first indication of the predetermined time period or the second indication of the predetermined number of transmissions is contained in the request for the synchronization information.

In some example embodiments, the apparatus is caused to, in response to the data to be transmitted to the second device, detect the system broadcasted information by: receiving an instruction from the second device to cease detection of system broadcasted information; and in response to the data to be transmitted to the second device, detecting the system broadcasted information.

In some example embodiments, the synchronization information comprises at least one of: timing of reception of the system broadcasted information; timing of generation of the system broadcasted information; time of transmission of the system broadcasted information; an index of the system broadcasted information; or an index of a system information block for carrying the system broadcasted information.

In some aspects, an apparatus implemented at a second device in a communication network, comprising: at least one processor; and at least one memory including computer program code; the at least one memory and the computer program code configured to, with the at least one processor, cause the apparatus to: transmit a request for synchronization information to a first device, the synchronization information being generated by the first device based on system broadcasted information received by the first device; and receive the synchronization information from the first device.

In some example embodiments, the apparatus is caused to transmit the request for the synchronization information to the first device by: in response to data to be transmitted to the first device, transmitting the request for the synchronization information to the first device.

In some example embodiments, the apparatus is further caused to: in response to receiving the synchronization information from the first device: reset a validity timer for a validity duration of the system broadcasted information, or update a link synchronization status for the first device.

In some example embodiments, the apparatus is further caused to: in response to receiving the synchronization information from the first device, transmit an acknowledge of the synchronization information to the first device.

In some example embodiments, the apparatus is further caused to: upon expiration of the validity timer or invalidity of the link synchronization status, transmit a further request for further synchronization information to the first device.

In some example embodiments, the apparatus is further caused to: in response to a prediction that no data to be transmitted by the second device to the first device within the validity duration of the system broadcasted information, transmit an instruction to the first device to cease detection of system broadcasted information.

In some example embodiments, the request for the synchronization information is transmitted to the first device on at least one of a physical downlink shared channel or a physical downlink control channel.

In some example embodiments, the apparatus is further caused to: transmit, to the first device, a first indication of a predetermined time period to maintain detection of latest system broadcasted information.

In some example embodiments, the apparatus is further caused to: transmit, to the first device, a second indication of a predetermined number of transmissions of the synchronization information to the second device.

In some example embodiments, at least one of the first indication of the predetermined time period or the second indication of the predetermined number of transmissions is contained in the request for the synchronization information.

In some example embodiments, the synchronization information comprises at least one of: timing of reception of the system broadcasted information; timing of generation of the system broadcasted information; time of transmission of the system broadcasted information; an index of the system broadcasted information; or an index of a system information block for carrying the system broadcasted information.

In some aspects, an apparatus at a first device comprises: means for, in response to at least one of data to be transmitted to a second device, or receiving a request for synchronization information from the second device, detecting system broadcasted information; means for, in response to receiving the system broadcasted information, generating the synchronization information based on the system broadcasted information; and means for transmitting the synchronization information to the second device.

In some example embodiments, the apparatus further comprises: means for, in response to at least one of receiving the system broadcasted information or receiving an acknowledge of the synchronization information from the second device, resetting a validity timer for a validity duration of the system broadcasted information.

In some example embodiments, the request for the synchronization information is received from the second device on at least one of a physical downlink shared channel or a physical downlink control channel.

In some example embodiments, the means for detecting the system broadcasted information comprises: means for receiving, from the second device, a first indication of a predetermined time period to maintain detection of latest system broadcasted information; and means for detecting the latest system broadcasted information periodically in the predetermined time period.

In some example embodiments, the means for detecting the system broadcasted information comprises: receiving, from the second device, a second indication of a predetermined number of transmissions of the synchronization information to the second device; and means for, in accordance with a determination that the number of transmissions of the synchronization information is below the predetermined number of transmissions, detecting the system broadcasted information.

In some example embodiments, at least one of the first indication of the predetermined time period or the second indication of the predetermined number of transmissions is contained in the request for the synchronization information.

In some example embodiments, the means for, in response to the data to be transmitted to the second device, detecting the system broadcasted information comprises: means for receiving an instruction from the second device to cease detection of system broadcasted information; and means for, in response to the data to be transmitted to the second device, detecting the system broadcasted information.

In some example embodiments, the synchronization information comprises at least one of: timing of reception of the system broadcasted information; timing of generation of the system broadcasted information; time of transmission of the system broadcasted information; an index of the system broadcasted information; or an index of a system information block for carrying the system broadcasted information.

In some aspects, an apparatus at a second device comprises: means for transmitting a request for synchronization information to a first device, the synchronization information being generated by the first device based on system broadcasted information received by the first device; and means for receiving the synchronization information from the first device.

In some example embodiments, the means for transmitting the request for the synchronization information to the first device comprises: means for in response to data to be transmitted to the first device, transmitting the request for the synchronization information to the first device.

In some example embodiments, the apparatus further comprises: means for in response to receiving the synchronization information from the first device: resetting a validity timer for a validity duration of the system broadcasted information, or updating a link synchronization status for the first device.

In some example embodiments, the apparatus further comprises: means for, in response to receiving the synchronization information from the first device, transmitting an acknowledge of the synchronization information to the first device.

In some example embodiments, the apparatus further comprises: means for, upon expiration of the validity timer or invalidity of the link synchronization status, transmitting a further request for further synchronization information to the first device.

In some example embodiments, the apparatus further comprises: means for, in response to a prediction that no data to be transmitted by the second device to the first device within the validity duration of the system broadcasted information, transmitting an instruction to the first device to cease detection of system broadcasted information.

In some example embodiments, the request for the synchronization information is transmitted to the first device on at least one of a physical downlink shared channel or a physical downlink control channel.

In some example embodiments, the apparatus further comprises: means for transmitting, to the first device, a first indication of a predetermined time period to maintain detection of latest system broadcasted information.

In some example embodiments, the apparatus further comprises: means for transmitting, to the first device, a second indication of a predetermined number of transmissions of the synchronization information to the second device.

In some example embodiments, at least one of the first indication of the predetermined time period or the second indication of the predetermined number of transmissions is contained in the request for the synchronization information.

In some example embodiments, the synchronization information comprises at least one of: timing of reception of the system broadcasted information; timing of generation of the system broadcasted information; time of transmission of the system broadcasted information; an index of the system broadcasted information; or an index of a system information block for carrying the system broadcasted information.

In some aspects, a computer readable storage medium comprises program instructions stored thereon, the instructions, when executed by a processor of a device, causing the device to perform the method according to some example embodiments of the present disclosure.

1. A method comprising:
at a first device,
in response to at least one of data to be transmitted to a second device, or receiving a request for synchronization information from the second device, detecting system broadcasted information;
in response to receiving the system broadcasted information, generating the synchronization information based on the system broadcasted information; and
transmitting the synchronization information to the second device.

2-19. (canceled)

20. An apparatus implemented at a first device, comprising:
at least one processor; and
at least one memory including computer program code;
the at least one memory and the computer program code configured to, with the at least one processor, cause the apparatus to:
in response to at least one of data to be transmitted to a second device, or receiving a request for synchronization information from the second device, detect system broadcasted information;
in response to receiving the system broadcasted information, generate the synchronization information based on the system broadcasted information; and
transmit the synchronization information to the second device.

21. The apparatus of claim 20, the apparatus is further caused to:
in response to at least one of receiving the system broadcasted information or receiving an acknowledge of the synchronization information from the second device, reset a validity timer for a validity duration of the system broadcasted information.

22. The apparatus of claim 20, wherein the request for the synchronization information is received from the second device on at least one of a physical downlink shared channel or a physical downlink control channel.

23. The apparatus of claim 20, wherein the apparatus is caused to detect the system broadcasted information by:
receiving, from the second device, a first indication of a predetermined time period to maintain detection of latest system broadcasted information; and
detecting the latest system broadcasted information periodically in the predetermined time period.

24. The apparatus of claim 20, wherein the apparatus is caused to detect the system broadcasted information by:
receiving, from the second device, a second indication of a predetermined number of transmissions of the synchronization information to the second device; and
in accordance with a determination that the number of transmissions of the synchronization information is below the predetermined number of transmissions, detecting the system broadcasted information.

25. The apparatus of claim 23, wherein at least one of the first indication of the predetermined time period or the second indication of the predetermined number of transmissions is contained in the request for the synchronization information.

26. The apparatus of claim 20, wherein the apparatus is caused to, in response to the data to be transmitted to the second device, detect the system broadcasted information by:
receiving an instruction from the second device to cease detection of system broadcasted information; and
in response to the data to be transmitted to the second device, detecting the system broadcasted information.

27. The apparatus of claim 20, wherein the synchronization information comprises at least one of:
timing of reception of the system broadcasted information;
timing of generation of the system broadcasted information;
time of transmission of the system broadcasted information;
an index of the system broadcasted information; or
an index of a system information block for carrying the system broadcasted information.

28. An apparatus implemented at a second device, comprising:
at least one processor; and
at least one memory including computer program code;
the at least one memory and the computer program code configured to, with the at least one processor, cause the apparatus to:
transmit a request for synchronization information to a first device, the synchronization information being generated by the first device based on system broadcasted information received by the first device; and
receive the synchronization information from the first device.

29. The apparatus of claim 28, wherein the apparatus is caused to transmit the request for the synchronization information to the first device by:
in response to data to be transmitted to the first device, transmitting the request for the synchronization information to the first device.

30. The apparatus of claim 28, the apparatus is further caused to:
in response to receiving the synchronization information from the first device:
reset a validity timer for a validity duration of the system broadcasted information, or
update a link synchronization status for the first device.

31. The apparatus of claim 28, the apparatus is further caused to:
in response to receiving the synchronization information from the first device, transmit an acknowledge of the synchronization information to the first device.

32. The apparatus of claim 30, the apparatus is further caused to:
upon expiration of the validity timer or invalidity of the link synchronization status, transmit a further request for further synchronization information to the first device.

33. The apparatus of claim 30, the apparatus is further caused to:
upon expiration of the validity timer or invalidity of the link synchronization status, transmit a further request for further synchronization information to the first device;
in response to a prediction that no data to be transmitted by the second device to the first device within the validity duration of the system broadcasted information, transmit an instruction to the first device to cease detection of system broadcasted information.

34. The apparatus of claim 28, wherein the request for the synchronization information is transmitted to the first device on at least one of a physical downlink shared channel or a physical downlink control channel.

35. The apparatus of claim 28, the apparatus is further caused to:
transmit, to the first device, a first indication of a predetermined time period to maintain detection of latest system broadcasted information.

36. The apparatus of claim 28, the apparatus is further caused to:
transmit, to the first device, a second indication of a predetermined number of transmissions of the synchronization information to the second device.

37. (canceled)

38. The apparatus of claim 28, wherein the synchronization information comprises at least one of:
timing of reception of the system broadcasted information;
timing of generation of the system broadcasted information;
time of transmission of the system broadcasted information;
an index of the system broadcasted information: or
an index of a system information block for carrying the system broadcasted information.

39-42. (canceled)
